(19) United States
(12) Patent Application Publication
(10) Pub. No.: US 2007/0283875 A1
(43) Pub. Date: Dec. 13, 2007

(54) EMERGENCY SIGNALING SYSTEM

(76) Inventor: Shayle Durkin, Farmingdale, NJ (US)

Correspondence Address: ADVANTIA LAW GROUP, 9035 SOUTH 1300 EAST, SUITE 200, SANDY, UT, 84094, US

(21) Appl. No.: 11/423,936

(22) Filed: Jun. 13, 2006

(51) Int. Cl. G09F 17/00

(52) U.S. Cl. 116/173

(57) ABSTRACT

A signaling system for emergencies. The system comprising a mast member, a coupling system, and a signaling device. The mast member including multiple elongated members capable of expanding or collapsing telescopically or elastically. A coupling system having a first coupling member connected to the mast member and to a second coupling member. The second coupling member being a suction cup or magnet, thereby facilitating the connection to an object or vehicle. A signaling device comprising a retractable flag of an attractive or light-reflecting color.

### FIELD OF THE INVENTION

The present invention relates to signaling systems, specifically to signaling systems for emergencies.

### DESCRIPTION OF THE RELATED ART

In the related art, it has been known to use flags, triangles, or other means to summon assistance or warn oncoming drivers of a disabled or stalled vehicle, or other vehicular emergency. Some improvements have been made in the field. Examples include, but are not limited to, the references described below, which references are incorporated by reference herein:

U.S. Pat. No. 4,633,215, issued to Anders et al., discloses a help summoning device for a disabled motor vehicle including a base housing securable to the vehicle and defining a battery compartment and a first pin socket mast mounting member electrically connected to the battery. A telescopically extendable mast having two sections axially collapsible to substantially the length of one section but remaining elongated once extended is hollow and includes a second pin socket in its base which can be coupled to the first pin socket to assemble the device. A bulb socket is secured in the upper end of the mast with electrical wires extending through the mast and being of sufficient length to extend between and interconnect the bulb socket and the second pin socket. A brightly colored rigid flag is secured to the upper mast section with a portion of the flag relieved around the bulb socket which receives a flasher bulb and a lens surrounding the bulb and engaging the upper end of the mast in the relieved portion of the flag. The device is secured to a vehicle either magnetically or through a Velcro fastener.

U.S. Pat. No. 3,895,348, by Palermo, discloses a warning device intended for mounting in a substantially concealed position on a vehicle and operable in a telescopic manner to provide above the cab portion of the vehicle a visual warning light, with a visual warning pennant adapted to be mounted on the telescopic member beneath the visual warning light.

U.S. Pat. No. 5,343,825, by Gazecimeon et al., discloses a flag comprised of a plurality of telescopic members. A knob member is connected to a tip of an inner end telescopic member and the knob member has a cross-section substantially equal to an outer base member. The knob is fastened to the base member when the flag is closed. A rod is pivotally connected to a base of the end member for radial movement away and toward the end member, and is connected to a side of a signaling sheet which is connected on its other side to the end member. The rod is biased away from the end member as the end member is extended from a remainder of the telescopic members and the rod returns to the end member as the end member is retracted into the remainder of the telescopic members. The rod holds at least part of the sheet taut when biased away from the end member. The sheet is kept taut and visible when the telescopic members are extended.

U.S. Pat. No. 5,483,916, by Kolvites et al., discloses a flag display device for mounting a flag or pennant to the exterior surface of a vehicle, such as a windshield, window, or roof including a flag staff having a flag affixed at one end and an annular base member at the opposite end. A suction cup depends from the base member for securing the flag display device to the surface. The base member also has a plurality of flexible legs radially extending from the annular ring to the surface which engage the surface at individual, separate and distinctly spaced contact points adjacent an outer perimeter of the suction cup when the suction cup is depressed, so that a force applied to the flag staff is transferred to the surface through the individual leg contact points and the suction cup and the flag staff remains stable even when wind forces are applied to the flag and flag staff. The flag display device further includes a mounting member for securing the flag staff to the base member. The mounting member provides an adjustment mechanism for adjusting a position of the flag staff relative to the base member.

U.S. Pat. No. 3,955,786, by Duddy, discloses a miniature magnetic base flagstaff for vehicle bodies comprised of a geometrically configured base plate member to which is affixed an upwardly extending flexible flagstaff appropriate for attachment thereto of a miniature flag of suitable type, and to the underside of the base plate member there is affixed a plurality of geometrically arranged elastomeric magnet members containing a dispersion therein of permanently magnetized ferrous particles which are secured to the underside of the base plate member.

The inventions heretofore known suffer from a number of disadvantages which include low or minimal visibility to other vehicular traffic, susceptibility to weather or other elements causing the device to become dislodged from the vehicle, bulky or large components not easily stored, the requirement of a power source or wiring, and/or the necessity of assembly of multiple parts.

What is needed is a signaling system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available signaling devices. Accordingly, the present invention has been developed to provide a signaling system that allow for maximum visibility while in use, very few moving parts, and easy and compact storage while not in use.

In one embodiment there is a signaling system for vehicles. The signaling system includes a mast member, a coupling system, and/or a signaling device. The mast member may include multiple, collinearly coupled elongated members capable of being extended or collapsed.

In another embodiment, the coupling system may include a first coupling member coupled to the mast member and/or a second coupling member coupled to the first coupling member. The coupling system may further include a third and/or fourth coupling member arranged similarly to the first and second, respectively. The second and/or fourth couplings members may be suction cups or magnets.

In yet another embodiment, the signaling device may include a flag coupled to a rod, where the rod may extend into a cavity in the mast member interior through an opening oriented orthogonally to the mast member. A pivot pin may be coupled to the mast member and/or traverse the cavity of the mast member. One end of the rod may be coupled to the pivot pin such that the rod may freely rotate in a circular manner about the pivot pin. A tab may be coupled to the side of the opening such that the rod, while extending orthogonal to the mast member, is prevented from rotating downward; but with the application of minimal force may be retracted into the cavity.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a perspective view of a signaling system, according to one embodiment of the invention;

FIG. 2 illustrates a perspective view of a signaling system on an expanded scale, according to one embodiment of the invention;

FIG. 3 illustrates a sectional view of a signaling system, according to one embodiment of the invention;

FIG. 4 illustrates a sectional view of a top portion of a signaling system, according to one embodiment of the invention; and

FIG. 5 illustrates a side view of a top portion of a signaling system, according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

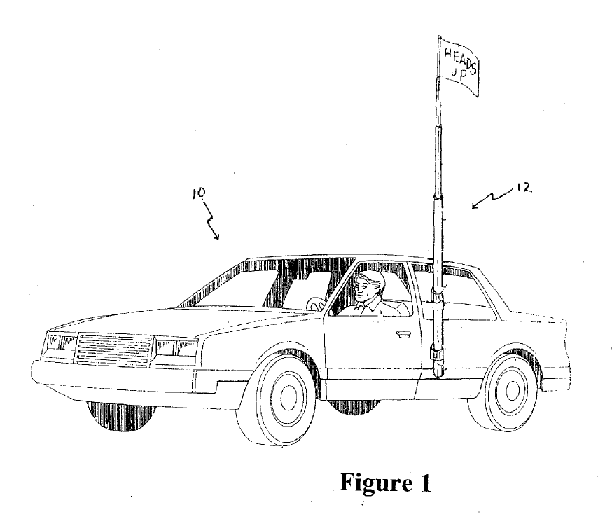

Referring now to the drawings, FIG. 1 illustrates a vehicle 10 and an occupant with a signaling system 12 deployed. Although not necessary for use of the signaling system 12, the vehicle 10 and/or its occupant are presumably stranded, disabled, or in some other emergency. The signaling system 12 is coupled to the side of the vehicle 10, preferably on the side of the vehicle 10 that is closest to traffic. Placing the device on vehicle's side provides for better visibility of the signaling system 12 to those providing aid, or to warn others of potential hazards.

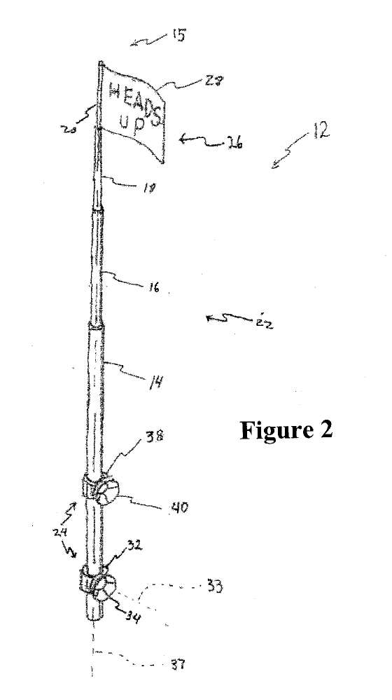

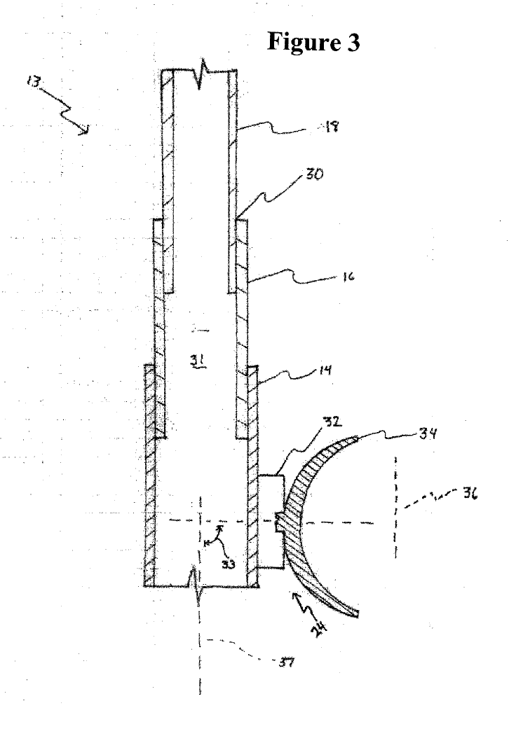

FIG. 2 illustrates the signaling system 12 unattached from the vehicle and on an expanded scale. In one embodiment the signaling system 12 is comprised of telescopically extendable elongated members 14, 16, 18, and 20 forming a mast member 22 with a coupling system 24 fastened to the mast member 22 (more fully shown in FIG. 3). Additionally, a signaling device 26 is coupled to the mast member 22. The signaling device 26 including a flag 28 or some other signaling mechanism.

Looking at FIGS. 2 and 3, the mast member 22 is comprised of multiple telescopically extendable elongated members 14, 16, 18, and 20 that contain a hollow inside 31. The mast member 22 is maintained in its elongated state by means of the frictional engagement between an adjacent lower and upper mast segment 30.

In another embodiment, the mast member 22 comprises elongated members 14, 16, 18, and 20 interconnected via an elastic cord as found in FIGS. 1 and 2 U.S. Pat. No. 4,979,531 by Toor et al., incorporated herein by reference. The elongated members 14, 16, 18, and 20 may be removably coupled one to another; such as, but not limited to interconnecting by male and female end portions.

The extendable ability of the mast member 22 to be allows for the signaling device 26 to be raised to a higher vantage point. This feature provides increased visibility to other vehicles. Furthermore, the collapsibility of the elongated members 14, 16, 18 and 20 allows for easy and convenient storage of the signal system 12 when not in use.

Attached to the mast member 22 is the coupling system 24 whose primary purpose is to secure the signaling system 12 to an object; for example, a vehicle 10. The coupling system 24 is comprised of a first coupling member 32 coupled to the mast member 22. A second coupling member 34, coupled to the first coupling member 32, is oriented substantially orthogonal 33 to the long axis 37 of the mast member 22, creating a surface 36 to receive a substantially planar object, such as the side of a vehicle 10. A third coupling member 38 is coupled to the mast member 22. Finally, a fourth coupling member 40, coupled to the third coupling member 38, is oriented in a similar fashion as the second coupling member 34, substantially orthogonal 33 to the long axis 37 of the mast member 22. The fourth coupling member 40 is arranged substantially parallel to orientation of the second coupling member 34, preferably in a manner so the second coupling member 34 and fourth coupling member 40 form an array; each coupling member increasing the strength of the attachment or coupling to the vehicle 10 or other object.

As illustrated, the first coupling member 32 and the third coupling member 38 are rings that wrap around or bracket the circumference of the mast member 22. The first coupling member 32 and third coupling member 38 may be made of plastic, steel, or some other material known in the art.

As illustrated, the second coupling member 34 and the fourth coupling member 40 are suction cups. The second coupling member 34 and the fourth coupling member 40 may be made from plastic, rubber or some other material known in the art. The multiple parts of the coupling system 24 provide a more secure coupling to the object or vehicle 10. This secure attachment helps to prevent dislodging of the signaling system 12 from the vehicle 10 during bad weather.

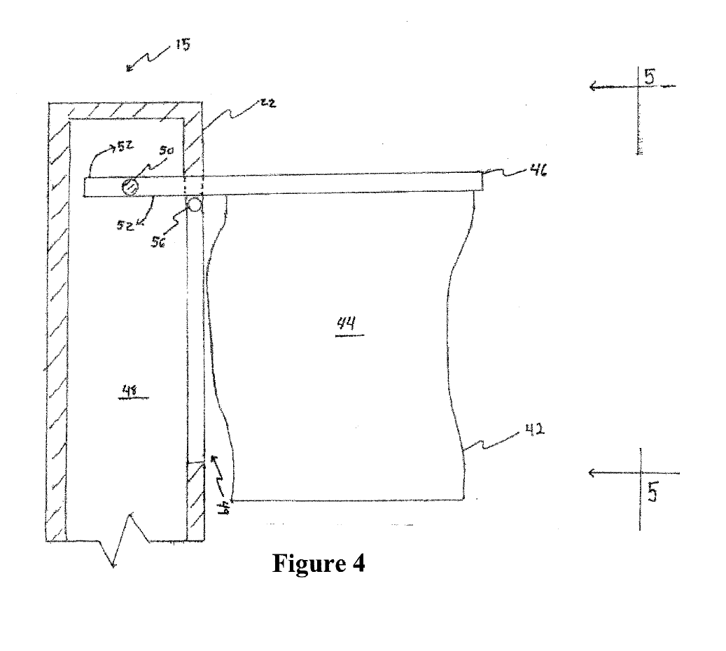

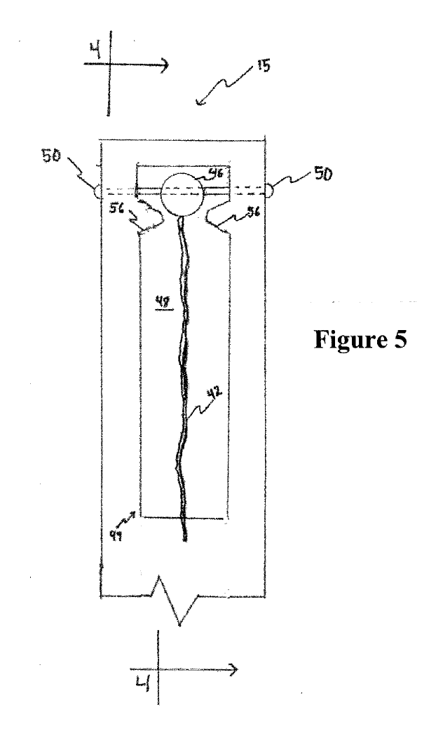

Finally, FIGS. 4 and 5 illustrate a cross section of a top portion of the mast member 22 in another embodiment of the signaling system 12. The flag 42, composed of a flexible material 44 (such as cloth, vinyl, etc.), is coupled to a rod 46 sufficiently rigid so as to hold the flag 42. The rod 46 extends into the cavity 48, disposed in the interior of the mast member 22, via an opening 49 in mast member 22; the opening 49 being oriented orthogonal to the mast member 22. Inside the cavity 48, the rod 46 is coupled to a pivot pin 50 which allows a rotation 52 of the rod 46 around the pivot pin 50 in a substantially circular manner. The pivot pin 50 is disposed substantially transversely in the cavity 48 and is coupled to the mast member 22.

Near the underside of the rod 46, on both interior sides of the opening 49, tabs 56 extend substantially orthogonally into the opening 49 of the mast member 22 a sufficient distance to prevent a downward motion of the rod 46 but still allow for rotation 52 of the rod 46 through the tabs 56 with the application of a minimal amount of force. Tabs 56 are composed of material sufficiently rigid (such as plastic, etc.) to support the rod 46 in a substantially orthogonal position to the mast member 22, but allow for the rod's 46 rotation 52 through the tabs 56 with minimal application of force.

When a vehicle becomes stranded or disabled, or during some other emergency; the signaling system 12 provides for maximum visibility, as well as coupled with easy assembly and placement. The user simply extends the elongated members 14, 16, 18, and 20 of mast member 22 to a desired height. The user then secures the signaling system 12 to the side of the vehicle 14 or other object via the coupling mechanism 24 preferably on the side of vehicle closest to traffic. In one embodiment the signaling system 24 includes a flag 26 which is coupled directly to the mast member 22 [see FIG. 2].

In another embodiment [FIGS. 4 and 5], the flag 42 is wound around the rod 46 and the rod 46 is rotated downward through the opening 49 and into the cavity 48 of the mast member 22. In operation, the user extends the mast member 22 as previously described. The user then pulls the rod 46 from the interior of the mast member 22 and rotates the rod 46 upwardly through the tabs 56. Once the rod 46 is extended substantially orthogonally to the mast member 22, and is supported by tabs 56, the user may unroll flag 42, and attach the extended signaling system 12 to the side of the vehicle 10 as previously described. Rotating the rod 46 and flag 42 into the interior of the mast member 22 provides the advantages of: a more compact storage, allows the elongated members 14, 16, 18, and 20 to more completely collapse, and prevents the tearing of or damage to the flag 42 while the signaling system 12 is not in use.

In yet another embodiment, the signaling device 28 may include a flag 42 and/or 26 coupled to the rod 46 wherein the flag 42 and/or 26 is kept taut and/or is retractable via a spring mechanism as found in FIG. 4 of U.S. Pat. No. 5,343,825 by Gazecimeon et al., incorporated herein by reference. In one embodiment the spring mechanism comprises a wire coil, from which one length, disposed internally along the top portion of the rectangular flag 42 and/or 26, extends substantially orthogonal to the mast member 22. Another length, coupled to the mast member 22, extends substantially parallel to the mast member 22. In operation, the user simply extends the mast member 22 until the cavity 48 and opening 49 are extended outward. The spring mechanism then automatically extends the flag 42 and/or 26 from the cavity 48. In collapsing the signaling device 28 the user simply applies downward pressure on the springing mechanism until the flag 42 and/or 26 is inside cavity 48.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although FIG. 1 shows the signaling system 12 on the rear door of the vehicle 10; the signaling system 12 could be placed on any part of the vehicle 10 or to any such object that the signaling system 12 could reasonably be attached. For example a vehicle 10 window or the like.

Additionally, although the illustrations show four elongated members 14, 16, 18, and 20, it is generally understood in the art that any reasonable number of axially collapsible elongated members may be used, such as: three, five, or six.

Additionally, although the Figures illustrate using suction cups 34 and 40 for the coupling system 24, it is understood in the art that any other reasonable means for securing the device to an object or the vehicle 10 may be used. For example, magnets, non stick glue, or other materials known in the art may be used for the coupling system 24.

Additionally, although the Figures illustrate a coupling system 24 with four coupling members 32, 34, 38, and 40, it is understood in the art that any reasonable number of coupling members may be employed, such as: six or eight.

Finally, it is envisioned that the components of the device may be constructed from a variety of materials. For example, the mast member 22 may be formed from aluminum, PVC, or any other material known in the art.

The flag 26 may be composed of any flexible or rigid material, and/or may be colored in such a way that attracts attention or reflects light (such as fluorescent orange, green, etc.).

Flag 42 may be composed of any flexible material, such as: cloth, vinyl, plastic, etc. The flag 42 may be colored in such a way that attracts attention or reflects light (such as fluorescent orange, green, etc.).

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A signaling system comprising:
a mast member, configured to provide height and support, including:
a first elongated member;
a second elongated member collinearly coupled to the first elongated member;
wherein the mast member has an extended mode and a collapsed mode;
a coupling system, configured to couple the first elongated member to another object, including:
a first coupling member coupled to the first elongated member; and
a second coupling member coupled to the first coupling member and oriented substantially orthogonal to the long axis of the first elongated member; and
a signaling device, configured to communicate a message, coupled to the mast member.

2. The signaling system of claim 1 wherein the mast member includes a cavity therein, having an opening oriented orthogonal to the mast member;
further comprising a pin, configured to support and suspend, transversely disposed through the cavity and coupled to the mass member;
a rod configured to support and suspend, comprising a first end wherein the first end is coupled to the pin such that of a first end and a second end wherein the first end is coupled to the pin as to allow the rod free rotation around the pin
a tab, configured to support, coupled to the side the opening such that with application of minimal force the rod may pivot through the tabs;
a flag coupled to the rod.

3. The signaling system of claim 1, wherein the second coupling member comprises a suction cup.

4. The signaling system of claim 1, wherein the second coupling member comprises a magnet.

5. The signaling system of claim 1, wherein, the coupling system further comprises:
a third coupling member coupled to the mast member; and
a fourth coupling member is oriented substantially orthogonal to the long axis of the mast member and parallel to orientation of the second coupling member.

6. The signaling system of claim 5, wherein the fourth coupling member comprises a suction cup

7. The signaling system of claim 5, wherein the fourth coupling member comprises a magnet.

8. The signaling system of claim 1, wherein the mast member further comprises:
A length of elastic cord disposed internal the first elongated member and;
disposed internal the second elongated members and;
coupled to one of the first and second elongated members.

9. The signaling system of claim 1, wherein the first elongated member is telescopically coupled to the second elongated member.

10. The signaling system of claim 1 wherein a flag is coupled to the mast member.

11. A signaling system comprising:
a mast member, configured to provide height and support, including:
a first elongated member;
a second elongated member collinearly coupled to the first elongated member;
wherein the mast member has an extended mode and a collapsed mode;
a coupling system, configured to couple the first elongated member to another object, including:
a first coupling member coupled to the first elongated member; and
a second coupling member coupled to the first coupling member and oriented substantially orthogonal to the long axis of the first elongated member; and
a signaling device, configured to communicate a message, wherein the mast member includes a cavity therein, having an opening oriented orthogonal to the mast member;
further comprising a pin, configured to support and suspend, transversely disposed through the cavity and coupled to the mass member;
a rod configured to support and suspend, comprising a first end wherein the first end is coupled to the pin such that of a first end and a second end wherein the first end is coupled to the pin as to allow the rod free rotation around the pin;
a tab, configured to support, coupled to the side the opening such that with application of minimal force the rod may pivot through the tabs;
a flag coupled to the rod.

12. The signaling system of claim 11, wherein the second coupling member comprises a suction cup.

13. The signaling system of claim 11, wherein the second coupling member comprises a magnet.

14. The signaling system of claim 11 wherein, the coupling system further comprises:
a third coupling member coupled to the mast member; and
a fourth coupling member is oriented substantially orthogonal to the long axis of the mast member and parallel to orientation of the second coupling member.

15. The signaling system of claim 14, wherein the fourth coupling member comprises a suction cup

16. The signaling system of claim 14, wherein the fourth coupling member comprises a magnet.

17. The signaling system of claim 11, wherein the mast member further comprises:
A length of elastic cord disposed internal the first elongated member and;
disposed internal the second elongated members and;
coupled to one of the first and second elongated members.

16. The signaling system of claim 14, wherein the first elongated member is telescopically coupled to the second elongated member.

17. The signaling system of claim 14, wherein a flag is coupled to the mast member.

18. A signaling system consisting essentially of:
a mast member, configured to provide height and support, including:
a first elongated member;
a second elongated member collinearly coupled to the first elongated member;
wherein the mast member has an extended mode and a collapsed mode;
a coupling system, configured to couple the first elongated member to another object, including:
a first coupling member coupled to the first elongated member;
a second coupling member coupled to the first coupling member and oriented substantially orthogonal to the long axis of the first elongated member;
a third coupling member coupled to the mast member; and
a fourth coupling member is oriented substantially orthogonal to the long axis of the mast member and parallel to orientation of the second coupling member.
a signaling device, configured to communicate a message, wherein the mast member includes a cavity therein, having an opening oriented orthogonal to the mast member;
further comprising a pin, configured to support and suspend, transversely disposed through the cavity and coupled to the mass member;
a rod configured to support and suspend, comprising a first end wherein the first end is coupled to the pin such that of a first end and a second end wherein the first end is coupled to the pin as to allow the rod free rotation around the pin;
a tab, configured to support, coupled to the side the opening such that with application of minimal force the rod may pivot through the tabs;
a flag coupled to the rod.

19. The signaling system of claim 18, wherein the second coupling member comprises a suction cup.

20. The signaling system of claim 18, wherein the second coupling member comprises a magnet.
